(19) United States
(12) Patent Application Publication
(10) Pub. No.: US 2007/0091733 A1
(43) Pub. Date: Apr. 26, 2007

(54) Reproducing device with repetitive reproduction function, repetitive reproduction program and repeating range resetting method

(75) Inventor: Tomo Kawahara, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/583,162

(22) Filed: Oct. 19, 2006

(30) Foreign Application Priority Data
Oct. 20, 2005 (JP) 2005-306281

(51) Int. Cl. G11B 21/08

(52) U.S. Cl. 369/30.04

(57) ABSTRACT

Disclosed are a reproducing device, and a repeating range resetting method and a repetitive reproduction function control program to be carried out by the device having a repetitive reproduction function of repetitively reproducing a repeating range and capable of carrying out a reproducing procedure for reproducing a single or plural sets of contents recorded on an information recording medium, wherein a repetition start point resetting request or a repetition end point resetting request requesting changing a repetition start point or a repetition end point of a repeating range is accepted during a repetitive reproduction procedure for repetitively reproducing a repeating range to set a new repeating range. The repetitive reproduction procedure is continued to reproduce contents in the new repeating range.

The present application is based on and claims priority of Japanese patent application No. 2005-306281 filed on Oct. 20, 2005, the entire contents of which are hereby incorporated by reference.

### BACKGROUND OF THE INVENTION

1. Field of the Invention

The present invention relates to a reproducing device for reproducing contents including images and sounds recorded on an information recording medium. More particularly, the present invention relates to a reproducing device having a repetitive reproduction function of repetitively reproducing contents in a predetermined range.

2. Description of the Related Art

A known reproducing device, such as a DVD player, for reproducing contents including images and sounds recorded on an information recording medium, such as a DVD, has a repetitive reproduction function to reproduce contents in a predetermined range repetitively. Techniques for setting a repeating range containing contents to be reproduced repetitively are disclosed in JP-Y 3096532, JP-A 2004-40705, and JP-A 2004-48611 (Patent Documents 1 to 3).

Basically, a known reproducing device sets a repeating range by specifying a repetition start point and a repetition end point. A repeating range setting operation can be practiced only in a repetitive reproduction function setting process which is practiced prior to the execution of a repetitive reproduction function. A repeating range changing operation or the like could not have been executed during the execution of the repetitive reproduction function.

### SUMMARY OF THE INVENTION

The present invention has been made in view of the foregoing circumstances and it is therefore an object of the present invention to provide a reproducing device, for reproducing contents recorded on an information recording medium, capable of facilitating a repeating range setting operation included in a repetitive reproduction function to reproduce repetitively the contents in a predetermined repeating range.

A first aspect of the present invention is directed to a reproducing device having a repetitive reproduction function of repetitively reproducing a repeating range and capable carrying out a reproducing procedure for reproducing a single or a plurality of sets of contents recorded on an information recording medium. The reproducing device includes a storage device storing a repeating range defined by a repetition start point and a repetition end point; a reproducing unit; a control unit; and an input unit, and that is configured such that a point where a point resetting request signal requesting resetting a repetition start point or a repetition end point is provided by operating the input unit during the execution of the repetitive reproduction function is stored as a new repetition start point or a new repetition end point in the storage device, and the repetitive reproduction function uses the new repetition start point or the new repetition end point.

The point resetting request signal requesting resetting a repetition start point or a repetition end point, namely, a set point change request signal, is accepted even during the execution of the repetitive reproduction function, the point where the point resetting request signal is provided is used as a new repetition start point or a new repetition end point to specify a new repeating range for which the repetitive reproduction function is executed.

In the reproducing device having a repetitive reproduction function according to the first aspect, the input unit may be provided with a repetition start point setting key and a repetition end point setting key, an input point entered by operating the repetition start point setting key during the execution of the repetitive reproduction function is used as a new repetition start point and a new repeating range having the new repetition start point is stored in the storage device or an input point entered by operating the repetition end point setting key during the execution of the repetitive reproduction function is used as a new repetition end point and a new repeating range having the new repetition end point is stored in the storage device.

When the repetition start point setting key or the repetition end point setting key is operated during the execution of the repetitive reproduction function, the repetition start point or the repetition end point is changed, and the repetitive reproduction function is executed using the new repetition start point or the new repetition end point.

In the reproducing device having a repetitive reproduction function according to the first aspect, a reproducing procedure may be started from a head part of one or a plurality of sets of contents stored on the information recording medium or a head part of one content unit being reproduced when a repetition start point resetting request signal is provided by operating the repetition start point setting key during the execution of the repetitive reproduction function, and then the repetitive reproduction function may be executed when it is decided that a reproducing position is within the repeating range.

The repetition start point resetting request signal is accepted even during the execution of the repetitive reproduction function. The reproducing process is executed from a head part of the contents or a head part of one content unit being reproduced by the repetitive reproduction function when a repetition start point resetting request signal is provided during the execution of the repetitive reproduction function. Subsequently, the execution of the repetitive reproduction function is continued when it is decided that a reproducing position is within the repeating range, which may be a new repeating range defined by the new repetition start point or the new repetition end point. The term “one content unit” signifies a content unit handled in a unit. Content units include contents such as “title” and “chapter” recorded on a DVD and “one piece of music” recorded on a CD.

In the reproducing device having a repetitive reproduction function according to the first aspect, a predetermined advancing time or an advancing time specified by a user may be stored in the storage device. By doing so, when a repetition start point resetting request signal is provided during the execution of the repetitive reproduction function, the reproducing procedure may be started from the repetition start point or a point advanced from a point where the repetition start point resetting request signal is provided by the advancing time, and the repetitive reproduction function may be executed when it is decided that the reproducing position is in the repeating range or the repetitive reproduction function is executed after storing the point advanced from the repetition start point or the point when the repetition start point resetting request signal is provided by the advancing time as a new repetition start point in the storage device.

Thus the repetition start point resetting request signal is accepted even during the execution of the repetitive reproduction function. When the repetition start point resetting request signal is provided, a repetition start point advancing procedure is started at a point advanced from the repetition start point or at the point where the repetition start point resetting request signal is provided by a predetermined advancing time or an advancing time specified by the user, or the point is used as a new repetition start point.

In the reproducing device having a repetitive reproduction function according to the first aspect, the reproducing procedure may be continued to an end part of one or a plurality of sets of contents recorded on the information recording medium or an end part of the content unit being reproduced after the reproducing procedure has reached the repetition end point when a repetition end point resetting request signal is provided during the execution of the repetitive reproduction function, and the reproducing procedure may return to the repetition start point and the repetitive reproduction function may be executed when a new repetition end point is set or the reproducing procedure reached the repetition end point.

Thus the repetition end point resetting request signal is accepted even during the execution of the repetitive reproduction function, the reproducing procedure is continued to an end part of contents or an end part of the content unit being reproduced after the reproducing procedure has reached the repetition end point when a repetition end point resetting request signal is entered during the execution of the repetitive reproduction function. And the reproducing procedure returns to the repetition start point (new repetition start point) and the repetitive reproduction function is executed when a new repetition end point is set or the reproducing procedure reaches the repetition end point (an end part of contents or an end part of the content unit).

In the reproducing device having a repetitive reproduction function according to the first aspect, a predetermined delay time or a delay time specified by the user may be stored in the storage device, and the repetitive reproduction function may be executed after storing a new repetition end point at the delay time from the repetition end point or from a point where the repetition end point resetting request signal is provided in the storage device.

Thus the repetition end point resetting request signal is accepted even during the execution of the repetitive reproduction function, and a new repeating range having a new repetition end point at the delay time from the repetition end point or from a point where the repetition end point resetting request signal is used.

In the reproducing device having a repetitive reproduction function according to the first aspect, the reproducing procedure is continued so as to meet a special reproduction procedure request signal provided by the user by operating the input unit during the execution of the repetitive reproduction function, and the repeating range is reproduced repetitively by the reproducing procedure.

The special reproduction procedure request signal is accepted during the execution of the repetitive reproduction function. The term “special reproduction procedure” signifies a reproducing procedure different from a normal reproducing procedure, such as a slow-motion reproducing procedure, a reverse slow-motion reproducing procedure, a quick forward reproducing procedure, a quick reverse reproducing procedure or a reverse reproducing procedure.

A second aspect of the present invention is directed to a repetitive reproduction function control program defining a reproducing procedure, to be carried out by a reproducing device that has a repetitive reproduction function of repetitively reproducing a repeating range and capable of carrying out a reproducing procedure for reproducing a single or a plurality of sets of contents recorded on an information recording medium and that includes a storage device storing a repeating range defined by a repetition start point and a repetition end point, a reproducing unit, a control unit, and an input unit. The program includes the steps of: accepting a repetition start point setting request signal during the execution of the repetitive reproduction function; storing a point where the repetition start point resetting request signal is accepted as a new repetition start point in the storage device when the repetition start point resetting request signal is provided; accepting a repetition end point resetting request signal during the execution of the repetitive reproduction function; and storing a point where the repetition end point resetting request signal is provided as a new repetition end point in the storage device.

A third aspect of the present invention is directed to a repeating range resetting method, to be carried out by a reproducing device that has a repetitive reproduction function of repetitively reproducing a repeating range and capable of carrying out a reproducing procedure for reproducing a single or a plurality of sets of contents recorded on an information recording medium and that includes a storage device storing a repeating range defined by a repetition start point and a repetition end point, a reproducing unit, a control unit, and an input unit. The method includes the steps of: determining a new repeating range defined by a new repetition start point and a repetition end point if a repetition start point resetting request signal is provided during the execution of a repetitive reproduction function or determining a new repeating range defined by a repetition start point and a new repetition end point if a repetition end point resetting request signal is provided during the execution of the repetitive reproduction function; and executing the repetitive reproduction function for the new repeating range.

The reproducing device having a repetitive reproduction function according to the aspects of the present invention and capable of repetitively reproducing a single or a plurality of sets of contents recorded on an information recording medium includes: a storage device storing a repeating range defined by a repetition start point and a repetition end point; a reproducing unit; a control unit; and an input unit. A point where a point resetting request signal requesting resetting a repetition start point or a repetition end point is provided by operating the input unit during the execution of the repetitive reproduction function is stored as a new repetition start point or a new repetition end point in the storage device, and the repetitive reproduction function uses the new repetition start point or the new repetition end point. Thus the point resetting request signal for resetting a repetition start point or a repetition end point is accepted even during the execution of the repetitive reproduction function, the point where the point resetting request signal is provided is used as a new repetition start point or a new repetition end point to define a new repeating range for which the repetitive reproduction function is executed. A repeating range changing operation can be performed during the execution of the repetitive reproduction function, which effectively enhances the operability of the reproducing device.

When the input unit of the reproducing device having a repetitive reproduction function according to the aspects of the present invention is provided with a repetition start point setting key and a repetition end point setting key, an input point specified by operating the repetition start point setting key during the execution of the repetitive reproduction function is used as a new repetition start point and a new repeating range having the new repetition start point is stored in the storage device or a repetition end point specified by operating the repetition end point setting key during the execution of the repetitive reproduction function is used as a new repetition end point and a new repeating range having the new repetition end point is stored in the storage device. Thus the repetition start point or the repetition end point can be changed (the repeating range can be changed) by operating the repetition start point setting key or the repetition end point setting key during the execution of the repetitive reproduction function. Thus the repeating range can be changed by a simple operation, which effectively enhances the operability of the reproducing device.

When the reproducing device having a repetitive reproduction function according to the aspects of the present invention starts the reproducing procedure from a head part of one or a plurality of sets of contents stored on the information recording medium or a head part of one content unit being reproduced by the repetitive reproduction function when a repetition start point advancing and resetting request signal is provided during the execution of the repetitive reproduction function, and then the repetitive reproduction function is executed when it is decided that a reproducing position is within the repeating range, the repeating range can be changed, and the reproducing procedure is started from a point advanced from the repetition start point when a repetition start point advancing and resetting request signal is provided. Thus the repeating range can be widened even during the execution of the repetitive reproduction function, which effectively enhances the operability of the reproducing device.

When the reproducing device having a repetitive reproduction function according to the aspects of the present invention continues the reproducing procedure to an end part of one or a plurality of sets of contents recorded on the information recording medium or an end part of the content unit being reproduced after the reproducing procedure has reached the repetition end point when a repetition end point resetting and delaying request signal is provided during the execution of the repetitive reproduction function, returns the reproducing procedure to the repetition start point when it is decided that a new repetition end point is set or the reproducing procedure has reached the end part, and executes the repetitive reproduction function. Thus a repeating range changing operation can be performed during the execution of the repetitive reproduction function, and the reproducing procedure is continued to a new repetition end point delayed from the repetition end point when a repetition end point delaying and resetting request signal is provided during the execution of the repetitive reproduction function. Thus the repeating range can be widened during the execution of the repetitive reproduction function, which effectively enhances the operability of the reproducing device.

When the reproducing device with a repetitive reproduction function according to the aspects of the present invention continues the reproducing procedure so as to meet a special reproduction request signal entered by the user by operating the input unit during the execution of the repetitive reproduction function, and the reproducing procedure reproduces the repeating range repetitively, the special reproduction request signal is accepted during the execution of the repetitive reproduction function, which effectively enhances the operability of the reproducing device.

### BRIEF DESCRIPTION OF THE DRAWINGS

The above and other objects, features and advantages of the present invention will become more apparent from the following description taken in connection with the accompanying drawings, in which:

FIG. 1 is a block diagram of an essential part of a DVD reproducing device in a first embodiment according to the present invention;

FIG. 2 is a flowchart of a procedure according to the present invention to be carried out by the DVD reproducing device;

FIG. 3 is a flowchart of a repetitive reproduction procedure in a first embodiment according to the present invention;

FIG. 4 is a schematic plan view of a remote controller for a DVD reproducing device in a first embodiment according to the present invention;

FIG. 5 is a block diagram of a part relevant to the present invention of a DVD reproducing device provided with a liquid crystal display (LCD);

FIG. 6 is a perspective view of the LCD incorporated into the DVD reproducing device;

FIG. 7 is a flowchart of a repetitive reproduction procedure in a second embodiment according to the present invention;

FIG. 8 is a flowchart of a repetition start point resetting procedure included in the repetitive reproduction procedure;

FIG. 9 is a flowchart of a repetition end point delaying procedure included in the repetitive reproduction procedure;

FIG. 10 is a schematic plan view of a remote controller for a DVD reproducing device provided with a liquid crystal display (LCD) in a second embodiment according to the present invention;

FIG. 11 is a diagram of assistance in explaining a repetition start point resetting procedure;

FIG. 12 is a diagram of assistance in explaining a repetition end point resetting procedure;

FIG. 13 is a flowchart of a repetitive reproduction function executing and ending procedure in a third embodiment according to the present invention;

FIG. 14 is a flowchart of a repetitive reproduction procedure in a third embodiment according to the present invention;

FIG. 15 is a flowchart of a precedent repeating range setting procedure included in a repetitive reproduction procedure in a third embodiment according to the present invention;

FIG. 16 is a flowchart of a succedent repeating range setting procedure included in the repetitive reproduction procedure in the third embodiment according to the present invention;

FIG. 17 is a diagram of assistance in explaining a repetition start point resetting procedure in a third embodiment according to the present invention;

FIG. 18 is a diagram of assistance in explaining a succedent repeating range setting procedure in a third embodiment according to the present invention;

FIG. 19 is a repeating range table;

FIG. 20 is a repetitive reproduction mode setting table;

FIG. 21 is a schematic plan view of a remote controller for a DVD reproducing device provided with a liquid crystal display (LCD) in a third embodiment according to the present invention;

FIG. 22 is another repetitive reproduction mode setting table;

FIG. 23 is a flowchart of another repetitive reproduction procedure;

FIG. 24 is a flowchart of a third repetitive reproduction procedure; and

FIG. 25 is a diagram of assistance in explaining a repeating range changing procedure included in a repetitive reproduction procedure.

### DESCRIPTION OF THE PREFERRED EMBODIMENTS

### First Embodiment

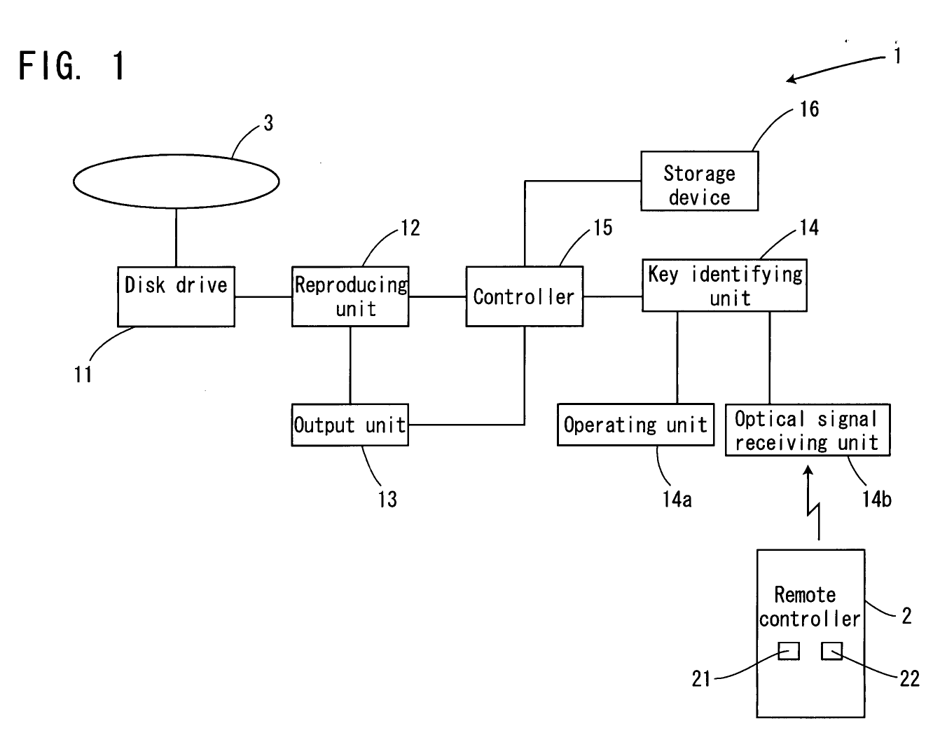

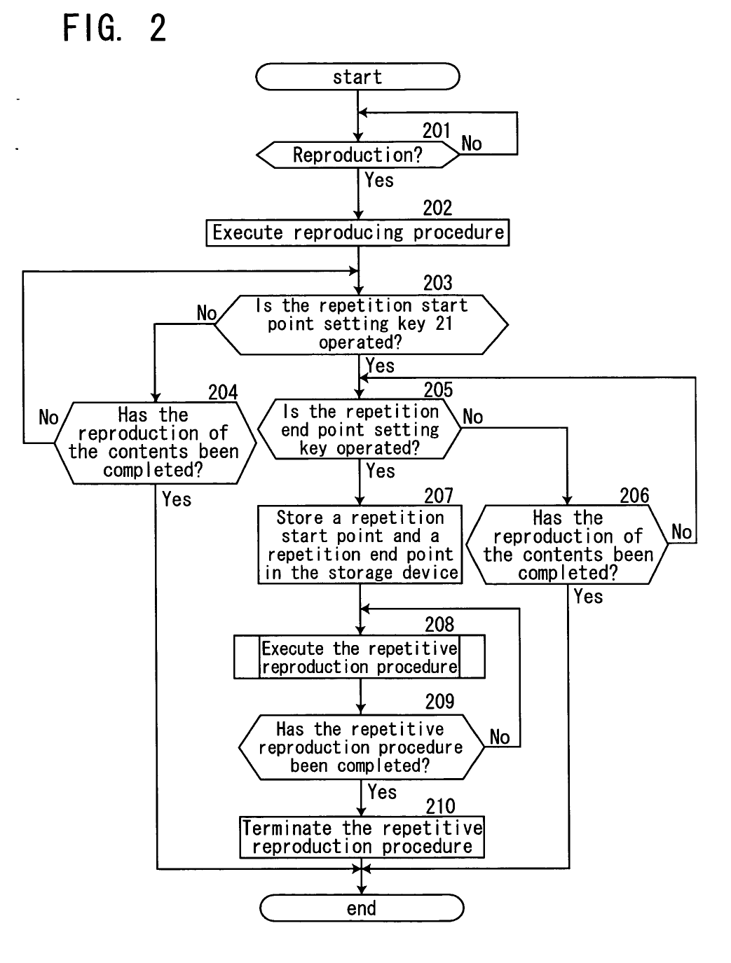

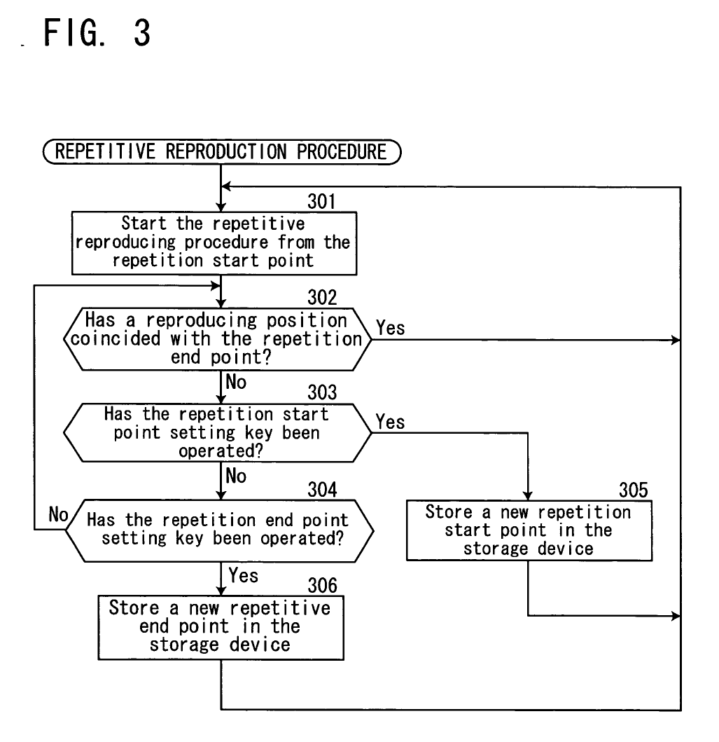

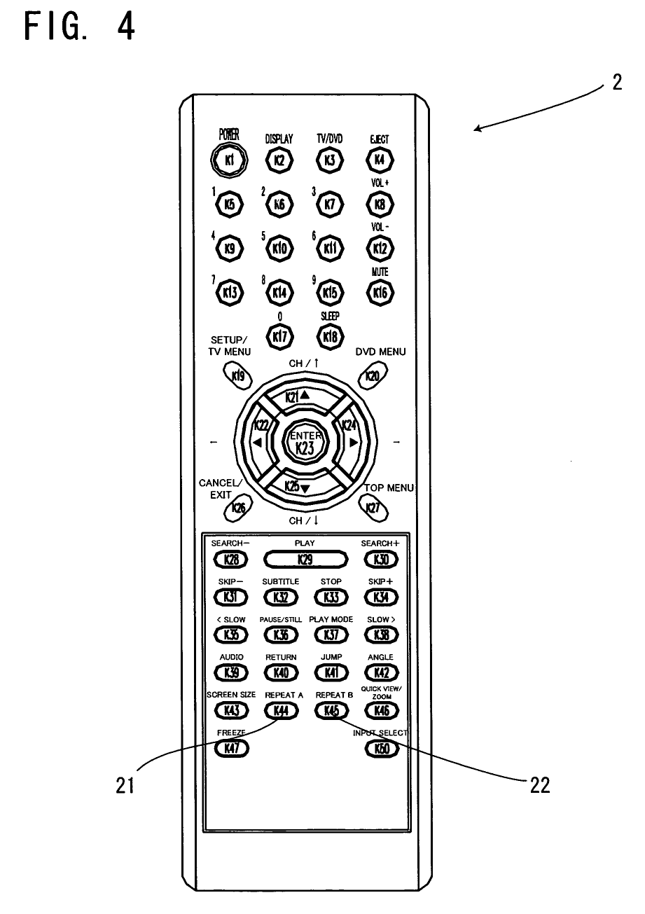

FIG. 1 is a block diagram of an essential part of a DVD reproducing device 1 in a first embodiment according to the present invention, FIGS. 2 and 3 are flowcharts of a procedure according to the present invention and FIG. 4 is a schematic plan view of a remote controller 2 for the DVD reproducing Device 1.

Referring to FIG. 1, the DVD reproducing device 1 includes a disk drive 11 for reading information from a DVD 3, namely, an information recording medium, a reproducing unit 12 provided with a decoder or the like for decoding data provided by the disk drive 11 and capable of carrying out a reproducing process for reproducing the contents of the DVD 3, an output unit 13 for sending video/sound signals generated by the reproducing unit 12 to an external display, such as a television set, a key identifying unit 14 for identifying a signal provided by an operating unit 14a, namely, an input interface operated by a user, or an optical signal receiving unit 14b that receives signals provided by the remote controller 2 and provides an identification signal, a controller 15 for generally controlling operations of the DVD reproducing device 1, and a storage device 16, namely, a storage means.

Referring to FIG. 4, the remote controller 2 is provided with a repetition start point setting key 21 and a repetition end point setting key 22 to set a repeating range.

Operations relevant to the present invention of the DVD reproducing device 1 will be described with reference to FIGS. 2 and 3. FIG. 2 is a flowchart of a procedure for setting, executing and ending a repetitive reproduction function.

The user operates the operating unit 14a or the remote controller 2, namely, an input device, to enter a contents reproducing request signal in step 201. Then, the disk drive 11, the reproducing unit 12 and the controller 15 operate to carry out a contents reproducing procedure for reproducing the contents of the DVD 3 in step 202. A query is made in step 203 to see whether or not the repetition start point setting key 21 is operated to enter a repetition start point resetting request signal. If the repetition start point setting key 21 has not been operated or the reproduction of the contents has been completed (step 204), the procedure is ended. If the repetition start point setting key 21 is operated, a point where the repetition start point setting key 21 is operated is stored temporarily as a repetition start point in the storage device 16 and a query is made in step 205 to see whether or not the repetition end point setting key 22 is operated to enter a repetition end point resetting request signal. If the repetition end point setting key 22 has not been operated or the reproduction of the contents has been completed (step 206), the procedure is ended. If the repetition end point setting key 22 is operated, a point where the repetition end point setting key 22 is operated is set as a repetition end point and the procedure goes to step 207.

In step 207, the repetition start point determined in step 203 and the repetition end point determined in step 205 are stored in the storage device 16. In step 208, a repetitive reproduction procedure shown in FIG. 3 is carried out. A query is made in step 209 to see whether or not the repetitive reproduction procedure has been completed. When a repetitive reproduction terminating instruction is given, i.e., if the response to the query in step 209 is affirmative, the repetitive reproduction procedure is terminated in step 210 and the procedure is ended. The repetitive reproduction terminating instruction is an instruction requiring the termination of only the repetitive reproduction procedure without stopping a contents reproducing operation or a disconnection instruction provided by operating a main switch to disconnect the DVD reproducing device 1 from a power supply.

Referring to FIG. 3 showing a flowchart of the repetitive reproduction procedure, a reproducing process for reproducing the contents is started from the repetition start point in step 301. The controller 15 reads the repetition start point from the storage device 16. The reproducing unit 12 controls the disk drive 11 on the basis of information about the repetition start point, reads data on the contents from the repetition start point and generates a video/sound signal from the data. The output unit 13 sends out the video/sound signal generated by the reproducing unit 12. Then a loop including steps 302 to 304 is executed. A query is made in step 302 to see whether or not a reproducing position has coincided with the repetition end point. A query is made in step 303 to see whether or not the repetition start point setting key 21 has been operated to request changing the repetition start point. A query is made in step 304 to see whether or not the repetition end point setting key 22 has been operated to request changing the repetition end point.

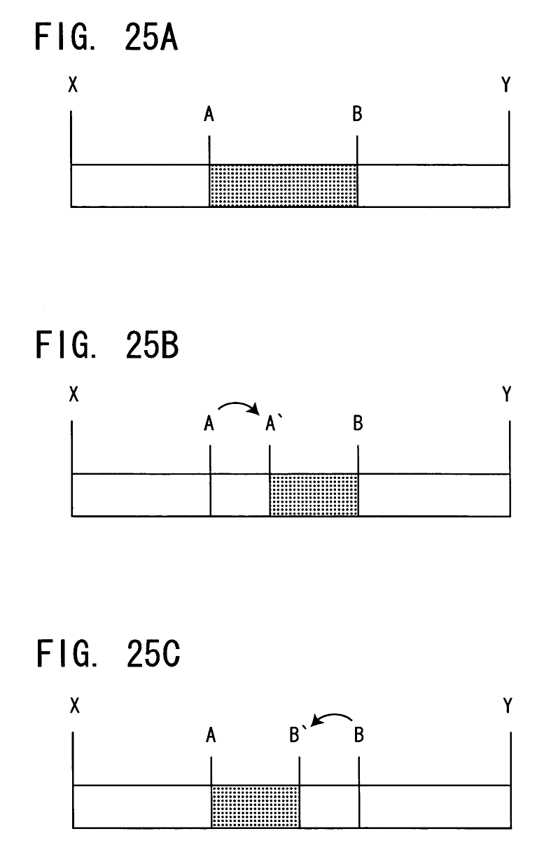

If the response in step 302 is affirmative, i.e., if it is decided that a reproducing position has coincided with the repetition end point, the procedure returns to step 301. Thus contents in the repeating range between the repetition start point and the repetition end point are reproduced repeatedly. FIG. 25 is a view of assistance in explaining a repeating range changing procedure included in a repetitive reproduction procedure. In FIG. 25, X and Y indicate the head and the tail, respectively, of the contents recorded on the DVD 3, and A and B indicate a repetition start point and a repetition end point, respectively. If the repetition start point setting key 21 is operated in step 303 at a point A′ shown in FIG. 25B during the repetitive reproduction process for repetitively reproducing contents between the points A and B included in the repetitive reproduction procedure, the point A′ is assumed to be a new repetition start point and the repetition start point A stored in the storage device 16 is overwritten with the new repetition start point A′ in step 305, and then the procedure returns to step 301 to repeat the repetitive reproduction process. If the repetition end point setting key 22 is operated in step 304 at a point B′ shown in FIG. 25C during the repetitive reproduction process for repetitively reproducing contents between the points A and , the point B′ is assumed to be a new repetition end point and the repetition end point B shown in FIG. 25C stored in the storage device 16 is overwritten by the new repetition start point B′ in step 306, and then the procedure returns to step 301 to repeat the repetitive reproduction process. When the repetition range is thus changed during the repetitive reproduction process to set a new repeating range A′-B shown in FIG. 25B or a new repeating range A-B′ shown in FIG. 25C, the contents in the new repeating range are reproduced repeatedly.

The DVD reproducing device 1 in the first embodiment accepts a repetition start point resetting request or a repetition end point resetting request during the execution of the repetitive reproduction function and uses the point when the repetition start point resetting request or the repetition end point resetting request is accepted as a new repetition start point or a new repetition end point for the subsequent execution of the repetitive reproduction function. Thus a repeating range setting operation and a repeating range changing operation can be performed even during the execution of the repetitive reproduction function, which effectively enhances the operability of the DVD reproducing device 1. Since the repeating range setting operation and the repeating range changing operation for narrowing the repeating range can be achieved by simply operating the repetition start point setting key 21 or the repetition end point setting key 22, the DVD reproducing device 1 is easy to operate. When only either of the repetition start point and the repetition end point is changed to narrow the repeating range, only one of the keys needs to be operated once. Such a repeating range changing operation can be intuitively understood, which enhances the operability of the DVD reproducing device 1. Although the repetition start point setting key 21 and the repetition end point setting key 22 of the first embodiment are used specially for specifying a desired repetition start point and a desired repetition end point, respectively, those keys 21 and 22 have additional functions.

The repeating range setting procedure shown in FIG. 2 defines a repeating range by a repetition start point and a repetition end point. Repeating ranges may be content units, such as a title and a chapter. Therefore, the term, “repeating range having a repetition start point and a repetition end point” does not literally signify only “repeating range defined by a repetition start point and a repetition end point” and may signify such information as a title or the like. When information about the repeating ranges stored in the storage device 16 is information about titles and such and a new repetition start point or a new repetition end point is set by the repeating range changing procedure shown in FIG. 3, the repeating range changing procedure may determine a new repetition end point to be paired with the new repetition start point or a new repetition start point to be paired with the new repetition end point by the reproducing unit 12 and the controller 15 by using information about the designation of a title or the like, may store the new repetition end point to be paired with the new repetition start point or the new repetition start point to be paired with the new repetition end point in the storage device 16. For example, when “TITLE1” is stored as a repeating range in the storage device 16, the end point of the “TITLE1” is read from the DVD 3 and the end point may be stored as a new repetition end point to be paired with the new repetition start point in the storage device 16.

### Second Embodiment

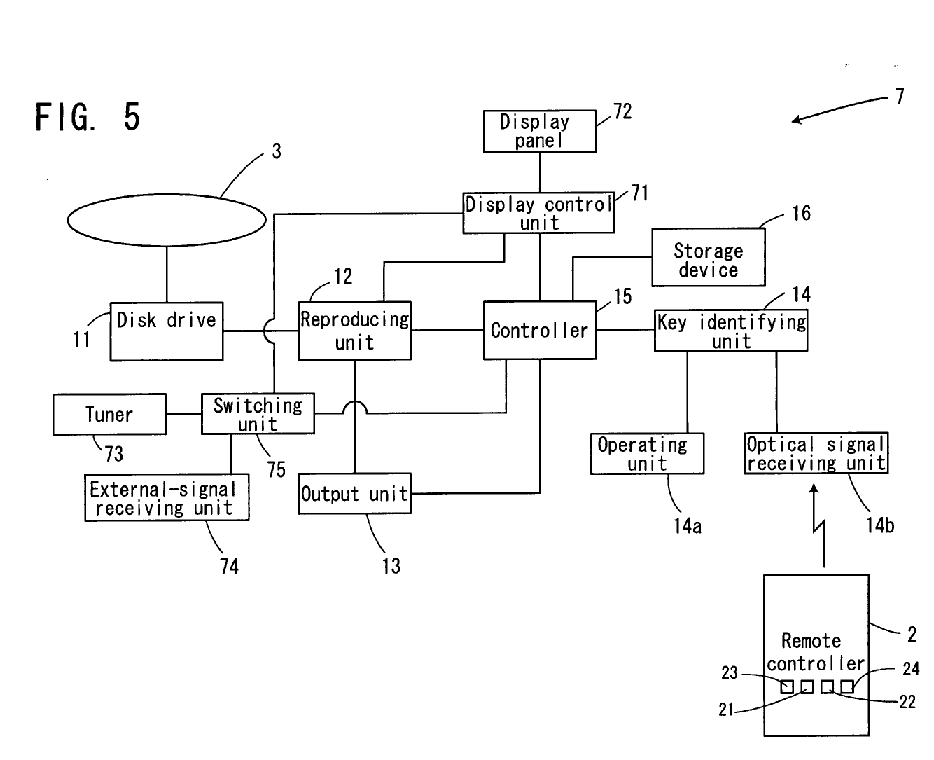

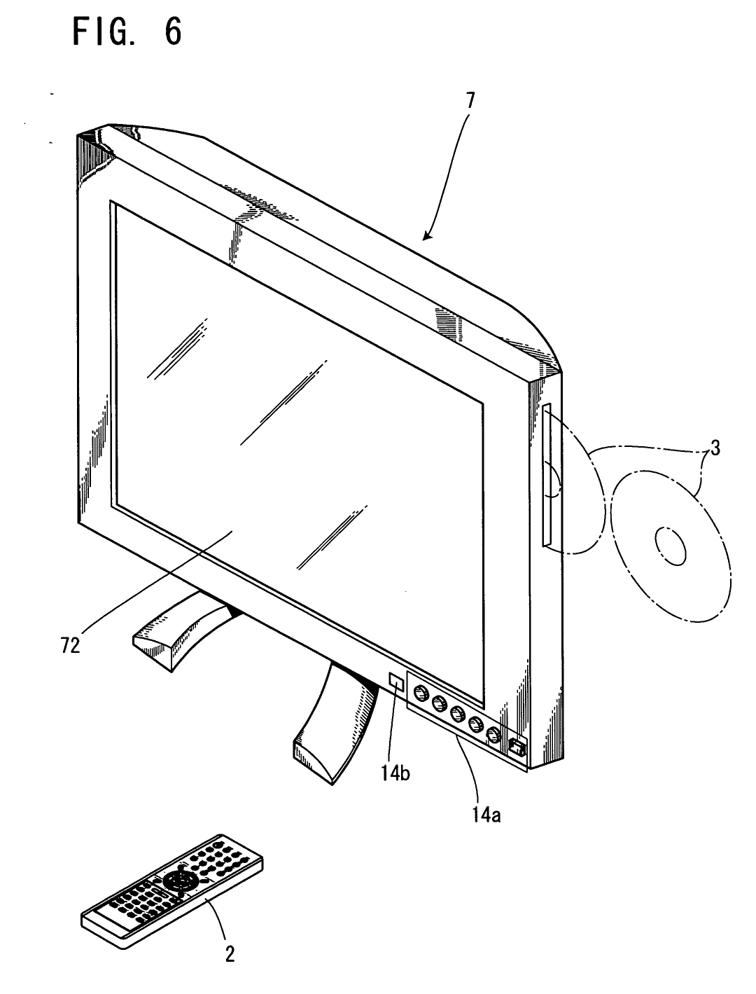

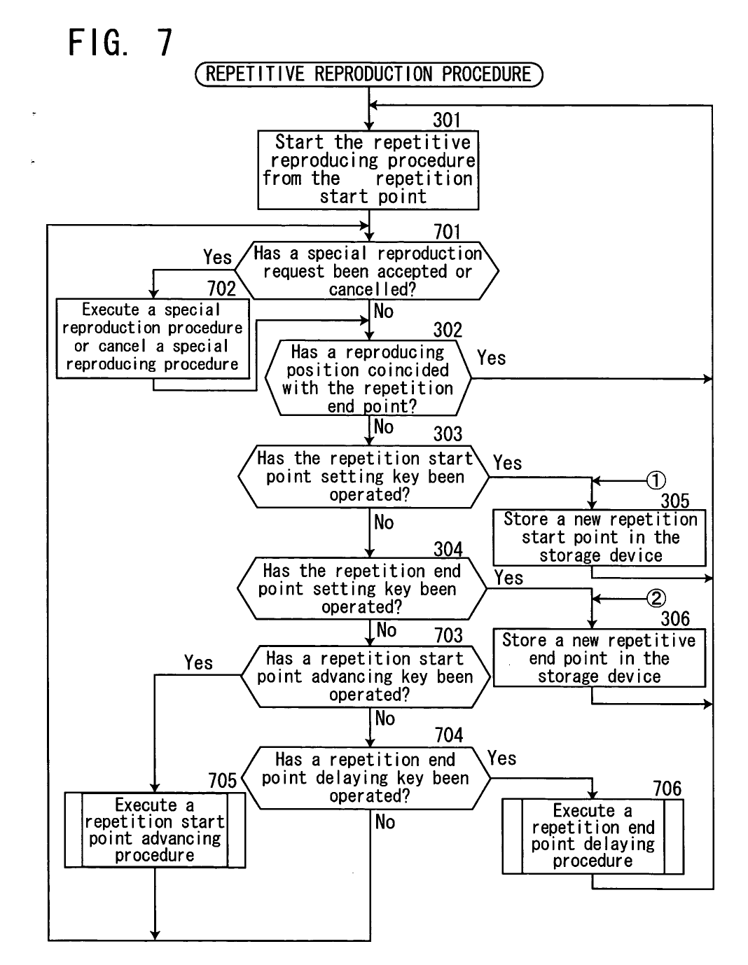

FIG. 5 is a block diagram of a part, relevant to the present invention, of a DVD reproducing device 7 in a second embodiment according to the present invention combined with a LCD, in which parts like or corresponding to those of the DVD reproducing device 1 in the first embodiment shown in FIG. 1 are designated by the same reference characters and the description thereof will be omitted or simplified. FIG. 6 is perspective view of the DVD reproducing device 7 provided with the LCD. FIGS. 7 to 9 are flowcharts of procedures to be carried out by the DVD reproducing device 7 in the second embodiment.

Referring to FIG. 5, the DVD reproducing device 7 provided with the LCD (hereinafter, referred to simply as “DVD reproducing device 7”) includes, similarly to the DVD reproducing device 1 in the first embodiment, a disk drive 11, a reproducing unit 12, an output unit 13, a key identifying unit 14, an operating unit 14a, an optical signal receiving unit 14b, a controller 15 and a storage device 16. The LCD 7 includes a display panel 72 for displaying images, a tuner 73 for receiving broadcast signals, an external-signal receiving unit 74 for receiving video/sound signals provided by an external device, such as a HDD recorder, a switching unit 75 for selectively sending out a signal provided by the tuner 73 or a signal provided by the external-signal receiving unit 74, and a display control unit 71 for making the display panel 72 display images represented by video signals received from the switching unit 75 or the reproducing unit 12. The DVD reproducing device 7 in the second embodiment is capable of carrying out special reproduction procedures including a slow-motion reproducing procedure, a reverse slow-motion reproducing procedure, a quick forward reproducing procedure, a quick reverse reproducing procedure and a reverse reproducing procedure in response to a slow-motion reproduction request signal, a reverse slow-motion reproduction request signal, a quick forward reproduction request signal, a quick reverse reproduction request signal and a reverse reproduction request signal.

The operations according to the present invention of the DVD reproducing device 7 will be described with reference to FIGS. 7 to 9. A procedure for setting, executing and ending a repetitive reproduction function is similar to that described previously in connection with the first embodiment with reference to FIG. 2 and hence the description thereof will be omitted. When necessary, the procedure will be described with reference to FIG. 2.

A repetitive reproduction procedure to be carried out after setting a repeating range set by steps 203 to 207 shown in FIG. 2 is shown in FIG. 7. Steps of the repetitive reproduction procedure shown in FIG. 7 conceptually similar to those of the repetitive reproduction procedure shown in FIG. 3 are denoted by the same numerals and the description thereof will be omitted or simplified.

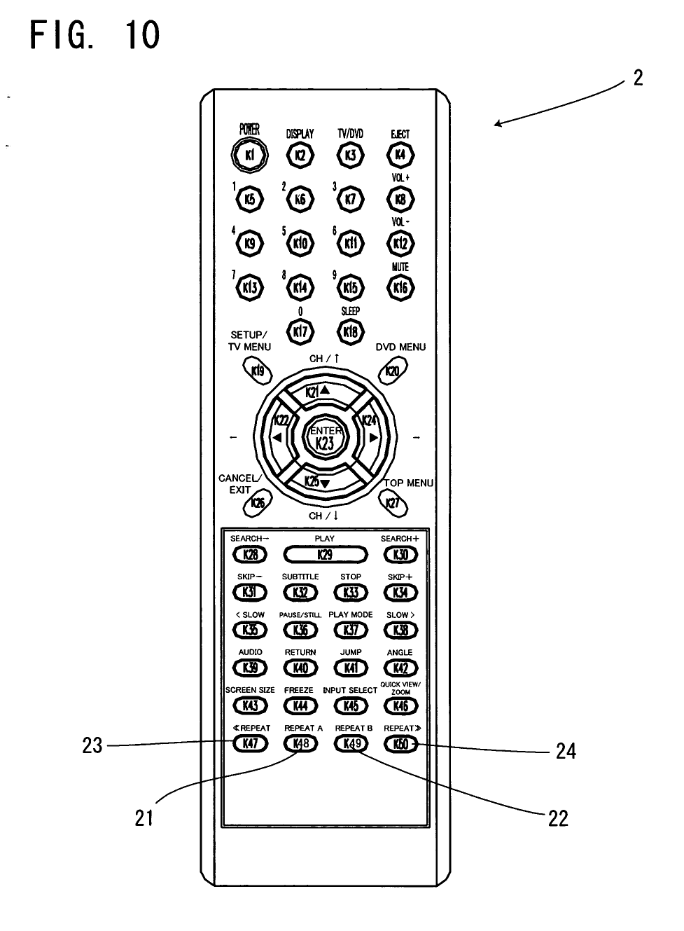

The repetitive reproduction procedure shown in FIG. 7 has a loop similar to the loop including steps 302 to 304 shown in FIG. 3 and additionally including step 701, namely, a special reproduction request accepting step, step 703, namely, a repetition start point resetting request accepting step, and step 704, namely, a repetition end point resetting request accepting step. When a special reproduction request signal or a special reproduction cancellation request signal is entered in step 701, the reproducing unit 12 and the controller 15 carry out a special reproduction procedure, such as a slow-motion reproducing procedure or cancel a special reproducing procedure to carry out a normal reproducing procedure in step 702. When a key 23 of a remote controller 2 shown in FIG. 10 is operated in step 703 to enter a repetition start point resetting request signal, a repetition start point advancing procedure is carried out in step 705. When a key 24 of the remote controller 2 is operated in step 704 to enter a repetition end point resetting request signal, a repetition end point delaying procedure is carried out in step 706.

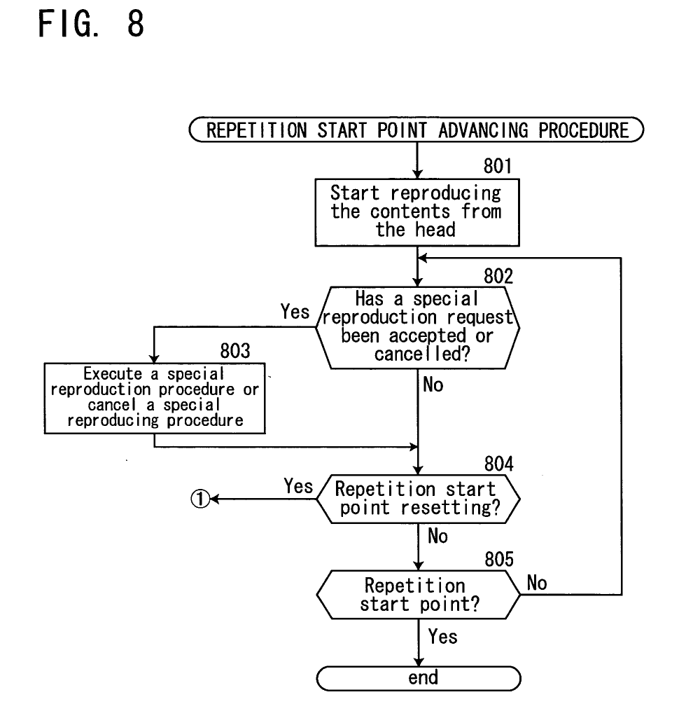

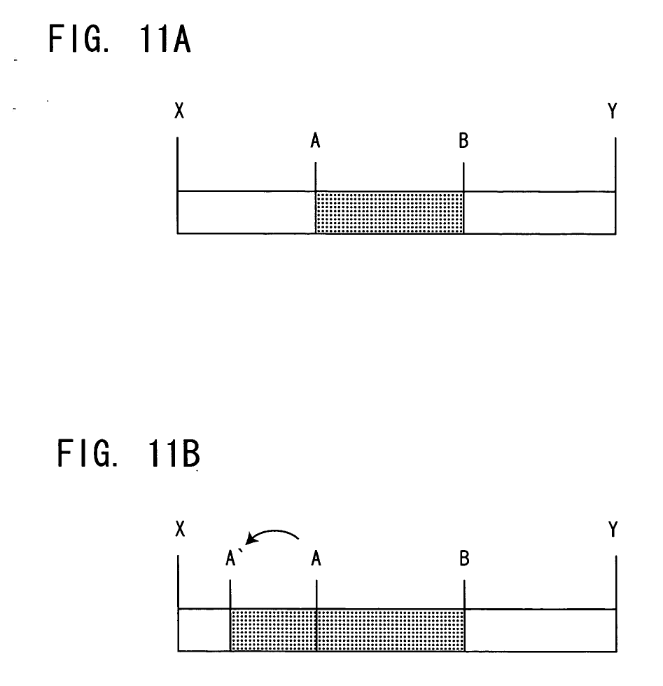

FIG. 8 is a flowchart of the repetition start point advancing procedure. When a repetition start point resetting request signal is entered, the repetition start point advancing procedure is started. In step 801, the repetition start point advancing procedure starts reproducing the contents stored on the DVD 3 from the head of the contents. FIG. 11 is a diagram of assistance in explaining the repetition start point advancing procedure. In FIG. 11, X and Y indicate the head and the tail, respectively, of the contents recorded on the DVD 3, and A and B indicate a repetition start point and a repetition end point, respectively. The repetition start point advancing procedure starts reproducing the contents from the head X of the contents. If the repetition start point setting key 21 is operated in step 804 at a point A′ shown in FIG. 11B during the repetition start point advancing procedure, the procedure jumps to step 305 (FIG. 7). The point A′ is assumed to be a new repetition start point and the repetition start point A stored in the storage device 16 is overwritten with the new repetition start point A′ in step 305. Contents in a new repeating range between the points A′ and B are reproduced repeatedly. When step 804 is executed, the reproducing point corresponds to the repeating range. If the repetition start point setting key 21 has not been operated before the reproducing operation reaches the repetition start point A shown in FIG. 11, i.e., if the reproducing point is within the repeating range, the repetition start point advancing procedure is ended in step 805 and the procedure returns to step 701 (FIG. 7) to continue the repetitive reproduction procedure. Steps 802 and 803 conceptually correspond to the special reproduction request accepting step 701 (FIG. 7) and the repetition start point resetting request accepting step 702 (FIG. 7), respectively.

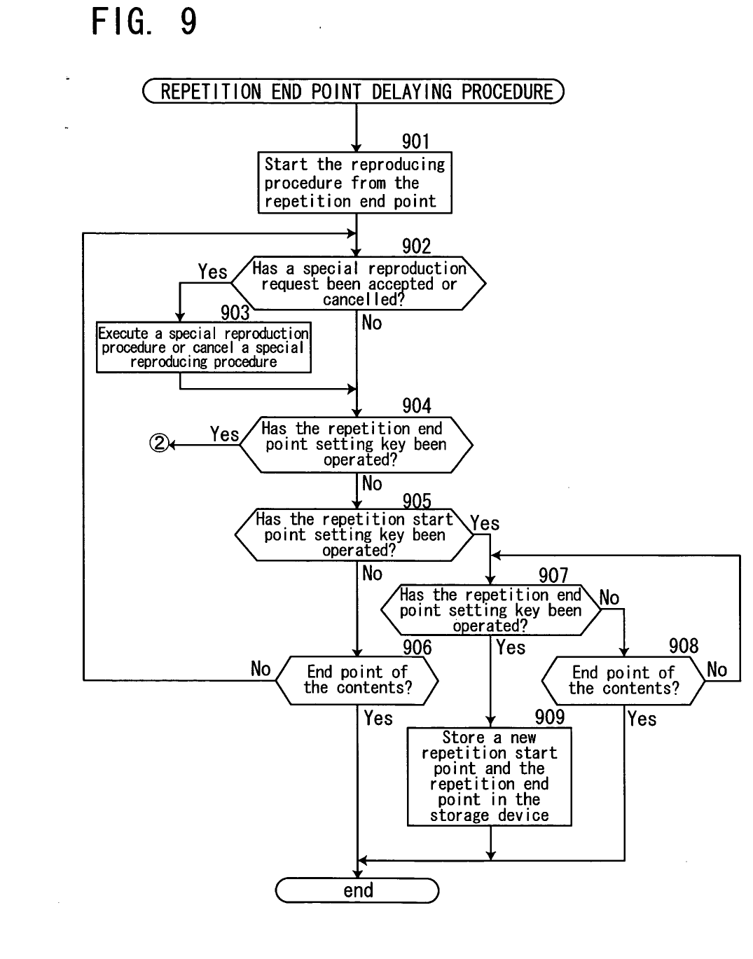

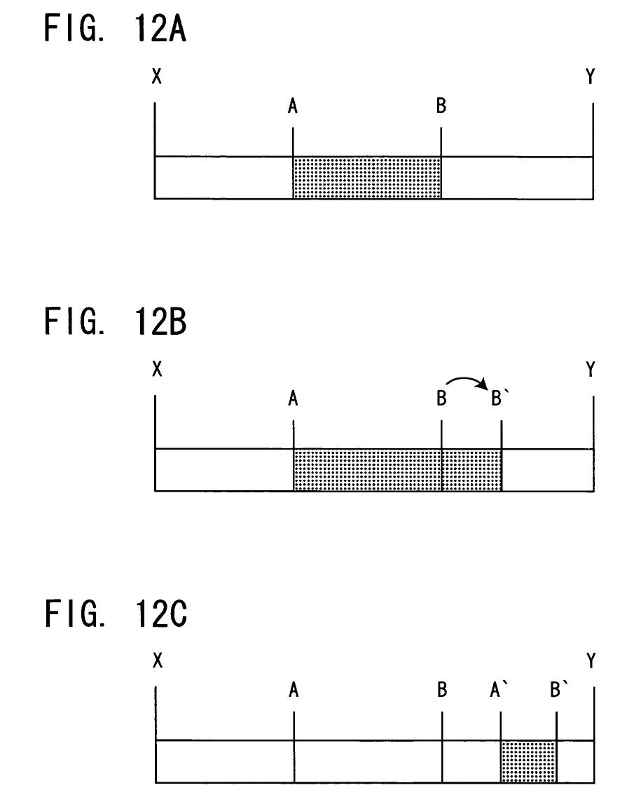

FIG. 9 is a flowchart of a repetition end point delaying procedure and FIG. 12 is a diagram of assistance in explaining the repetition end point delaying procedure. When a repetition end point resetting request signal is entered, the repetition end point delaying procedure is carried out. In step 901, the reproducing procedure is started from the repetition end point B (FIG. 12) of the contents. When the repetition end point setting key 22 is operated in step 904 during the reproducing procedure, the reproducing procedure jumps to step 306 (FIG. 7). In step 306, the point where the repetition end point setting key 22 is operated is assumed to be a new repetition endpoint B′ shown in FIG. 12B, the repetition end point B stored in the storage device 16 is overwritten with the new repetition end point B′. Thus a new repeating range defined by the points A and B′ as shown in FIG. 12B is set.

When the repetition start point setting key 21 is operated at a point A′ shown in FIG. 12C in step 905, the point A′ is stored temporarily in the storage device 16 as a temporary repetition start point, and then a loop including steps 907 and 908 is executed. If the repetition end point setting key 22 has not been operated before the reproducing procedure reaches the tail Y of the contents shown in FIG. 12, the repetition end point delaying procedure is ended and the temporary repetition start point A′ is cancelled. Then, the procedure returns to step 301 (FIG. 7) and the following steps are repeated without changing the repeating range. If the repetition end point setting key 22 is operated in step 907 of the loop including steps 907 and 908, a point where the repetition end point setting key 22 is operated is assumed to be a new repetition end point B′ shown in FIG. 12C. The repetition start point A shown in FIG. 12 and the repetition end point B stored in the storage device 16 are rewritten with the temporary repetition start point A′ and the new repetition end point B′, respectively. Thus a new repeating range defined by the points A′ and B′ as shown in FIG. 12C is set.

When neither of the repetition start point setting key 21 and the repetition endpoint setting key 22 is operated before the reproducing procedure reaches the tail Y of the contents shown in FIG. 12 in step 906, the repetition end point delaying procedure is ended and the procedure returns to step 301 (FIG. 7) and the following steps are repeated without changing the repeating range. A special reproduction request is accepted during the extended reproducing procedure in steps 902 and 903. Steps 902 and 903 are conceptually similar to steps 701 and 702 (FIG. 7), respectively. When a repetition end point resetting signal is entered in step 704 (FIG. 7), the reproducing point jumps to the repetition end point. If a repetition end point resetting request is made, the repetition end point delaying procedure may be carried out after the reproducing procedure has been continued to the repetition end point.

The DVD reproducing device 7 provided with the LCD in the second embodiment permits the repeating range changing operation during the execution of the repetitive reproduction function. When a repetition start point resetting request is made, the reproducing procedure is started from an advanced point before the repetition start point. When a repetition end point resetting request is made, the reproducing procedure is continued to a delayed point after the repetition end point. Thus the repeating range can be freely changed during the execution of the repetitive reproduction function. Thus the DVD reproducing device is excellent in operability. Since the special reproduction request is accepted even during the execution of the repetitive reproduction function, the reproducing procedure can quickly reach a point where, for example, a quick forward reproducing operation or a quick reverse reproducing operation is to be started. A desired repeating range can be accurately set by using a slow-motion reproduction. Thus the DVD reproducing device is excellent in operability. If the reproducing procedure reaches the boundary point of the repeating range, such as the repetition start point A of the repeating range defined by the points A and B shown in FIG. 11A, by quick reverse reproduction, the reproducing procedure may be cancelled and the normal reproducing procedure may be started or the special reproduction procedure may be continued after the reproducing procedure has reached the repetition start point A. For example, the quick reverse reproduction may be started from the point B after the reproducing procedure has reached the point A.

In this embodiment, the repetition start point is changed temporarily for the head of all the contents recorded on the DVD 3 when the repetition start point resetting request is made or the repetition end point is changed temporarily for a point corresponding to the tail of all the contents recorded on the DVD 3 when the repetition end point resetting request is made. The content unit including all the contents recorded on the DVD 3 may be replaced with a content unit including a title or a content unit including a chapter for temporary repeating range change.

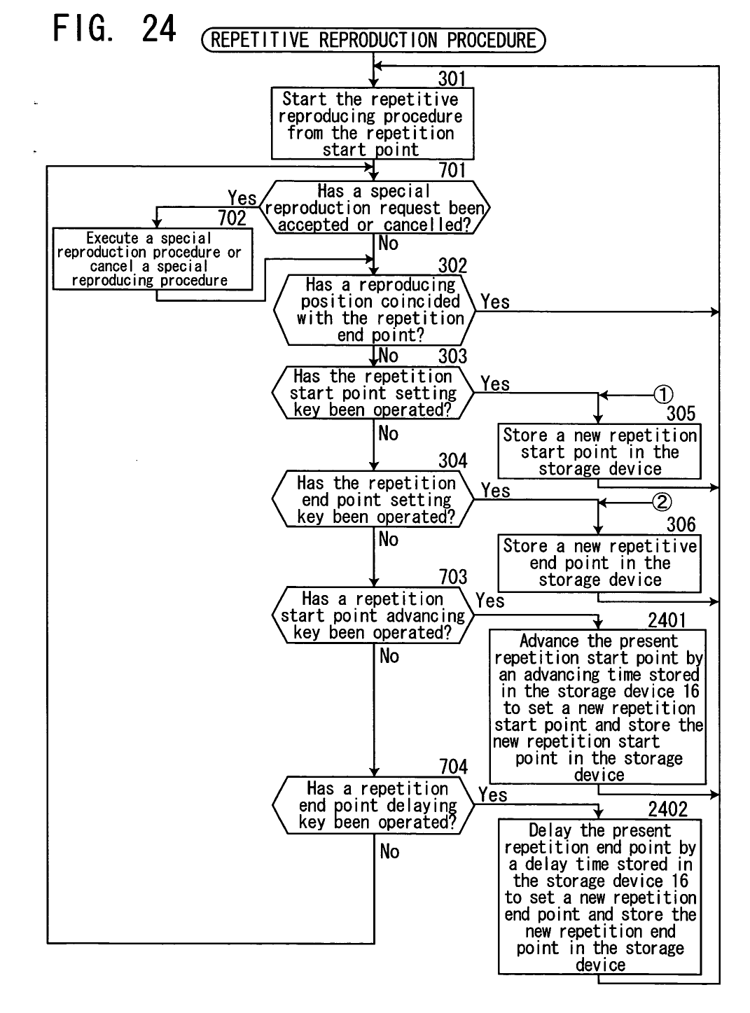

A predetermined advance time and a predetermined delay time, or an advance time and a delay time specified by the user may be stored in the storage device 16 and, when the repetition start point resetting request or the repetition end point resetting request is made, the repeating range may be changed temporarily by the advance time or the delay time to start the contents reproduction in step 801 (FIG. 8) from a point advanced from the present reproducing point by the advance time stored in the storage device 16 or to start the contents reproduction in step 901 (FIG. 9) at a point delayed from the present reproducing point by the delay time stored in the storage device 16. As shown in FIG. 24, in which steps conceptually similar to those shown in FIG. 7 are designated by the same reference characters, when a repetition start point resetting request is made in step 703 or a repetition end point resetting request is made in step 704, a repeating range may be changed by using the advance time in step 2401 or by using the delay time in step 2402. A point where the resetting request is made, the repetition start point or the repetition end point may be used as a reference point. In FIG. 24, a present point, namely, a point where the resetting request is made, is used as a reference point. A repeating range of a predetermined length can be easily set by using the predetermined advance time and the predetermined delay time or the advance time and the delay time specified by the user, which enhances the operability of the DVD reproducing device.

### Third Embodiment

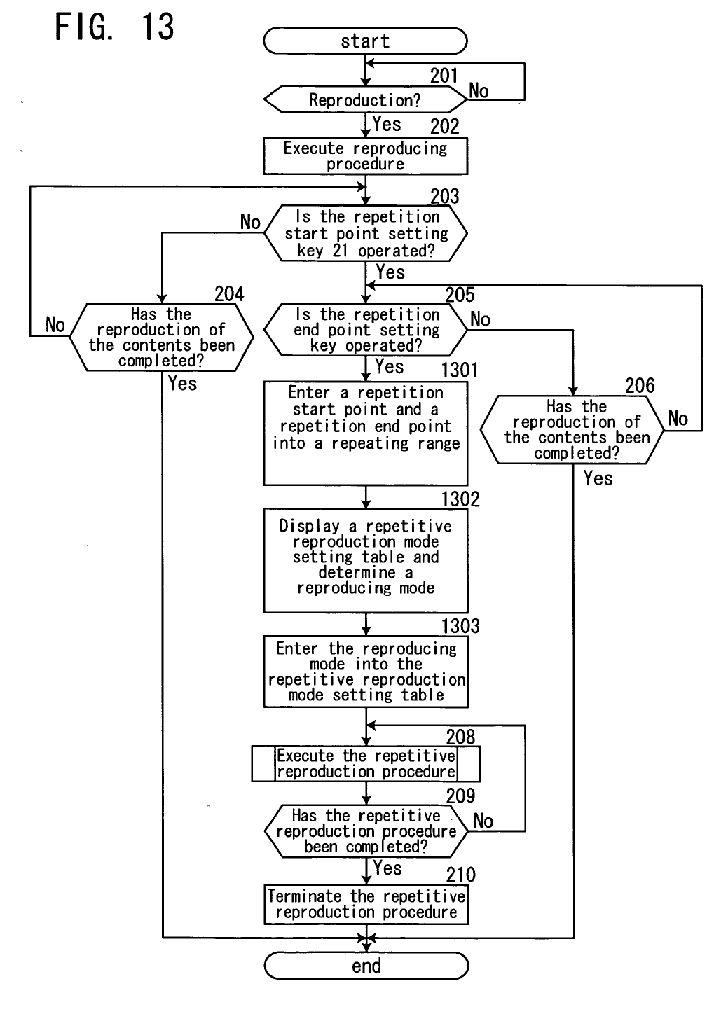

FIGS. 13 to 16 are flowcharts of procedures to be carried out by a part, relevant to the present invention, of a DVD reproducing device in a third embodiment according to the present invention combined with a LCD. The construction of the DVD reproducing device in the third embodiment is the same as that of the DVD reproducing device in the second embodiment shown in FIG. 5 and hence the description thereof will be omitted. When necessary, the construction of the DVD reproducing device in the third embodiment will be described with reference to FIG. 5.

FIG. 13 is a flowchart of a repetitive reproduction function setting, executing and ending procedure in a third embodiment according to the present invention. Steps of the repetitive reproduction procedure conceptually similar to those of the repetitive reproduction procedure in the first embodiment shown in FIG. 2 are designated by the same reference numerals and the description thereof will be omitted or simplified.

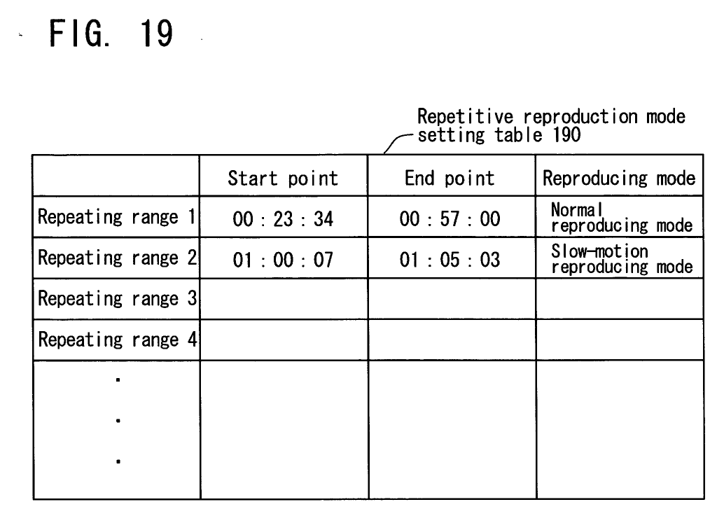

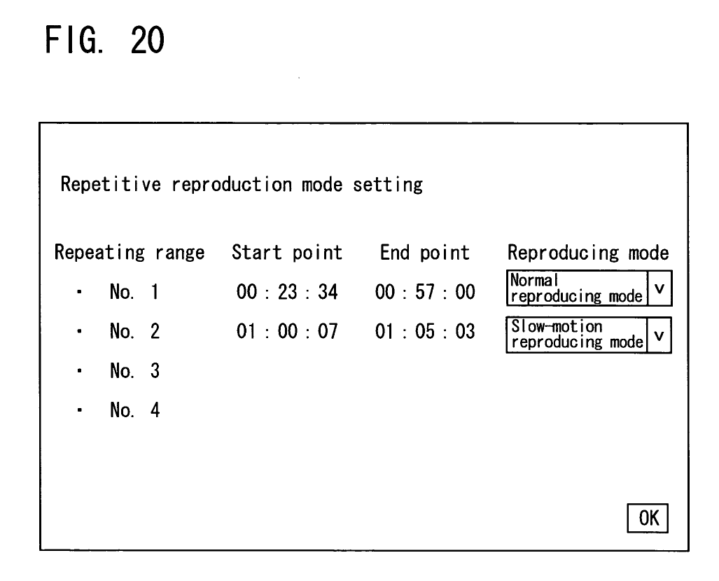

The user sets a repeating range by executing steps 203 to 206. Subsequently, a repetition start point and a repetition end point defining the repeating range set by executing steps 203 to 206 are entered into a repeating range table stored in the storage device 16 in step 1301. FIG. 19 shows a repetitive reproduction mode setting table 190 by way of example. In step 1302, a repetitive reproduction mode setting table as shown in FIG. 20 is displayed on the display panel 72. A displaying process for displaying the repetitive reproduction mode setting picture is carried out by the controller 15 having an OSD signal generating function and the display control unit 71. A reproducing mode, such as a slow-motion reproducing mode or a quick forward reproducing mode, is determined. In step 1303, the reproducing mode is entered into the repetitive reproduction mode setting table 190 stored in the storage device 16. The user operates the remote controller 2 and the operating unit 14a according to instructions displayed on the display panel 72 to enter user's instructions and to achieve information acquisition. The key identifying unit 14 and the controller 15 display user's operations on the display panel 72 to acquire necessary information.

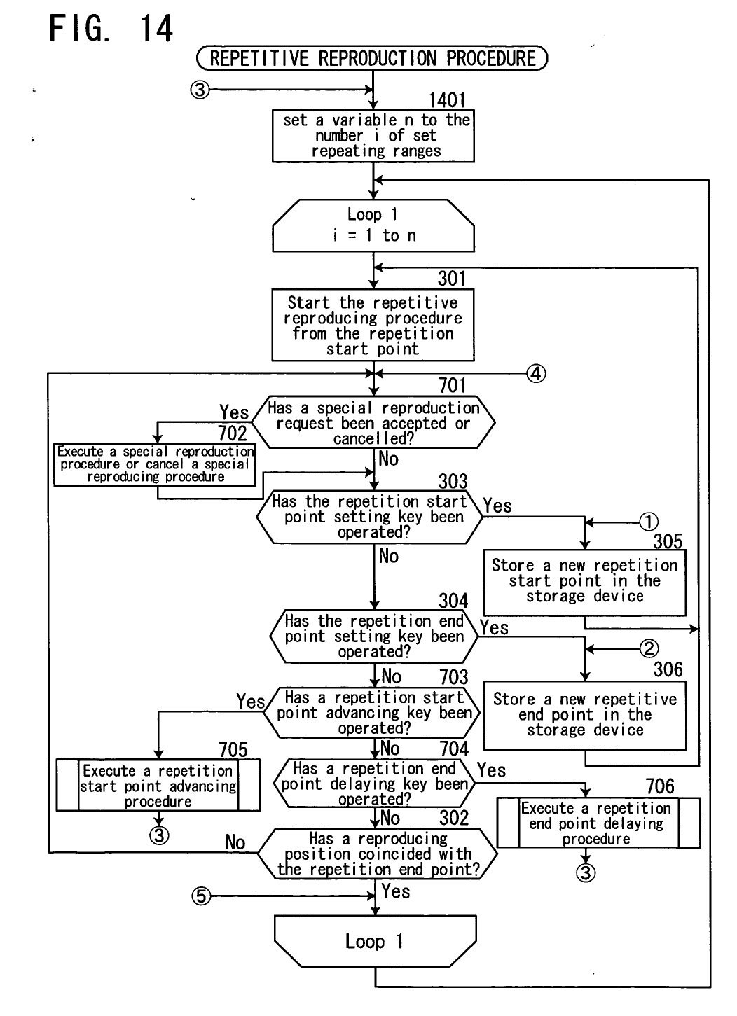

A repetitive reproduction procedure shown in FIG. 14 is carried out in step 208 after the repetitive reproduction function has been thus set. Steps of the repetitive reproduction procedure conceptually similar to those of the repetitive reproduction procedure in the second embodiment shown in FIG. 7 are denoted by the same numerals and the description thereof will be omitted or simplified.

Upon the start of the repetitive reproduction procedure shown in FIG. 14, the controller 15 refers to the repetitive reproduction mode setting table 190 stored in the storage device 16 to read the number i of set repeating ranges and sets a variable n to the number i of set repeating ranges in step 1401. A plurality of repeating ranges can be set. A loop 1 is repeated n times (i=1 to n) to carry out n reproduction procedures. More specifically, when the loop 1 is repeated until i=n, reproduction procedures (special reproduction procedures) respectively having repeating ranges are carried out sequentially once. For example, when two repeating ranges, namely, a first repeating range 1 and a second repeating range 2, are set as shown in FIG. 19, the first repeating range 1 is reproduced in the normal reproduction mode, and then the second repeating range 2 is reproduced in the slow-motion reproducing mode. Reproducing steps of the loop 1 are repeated until a repetitive reproduction end command is given in step 209 (FIG. 13). The loop 1 is repeated to carry out the reproducing procedure for reproducing the first repeating range 1 and the reproducing procedure for reproducing the second repeating range 2 alternately.

In step 301 in the loop 1, the reproduction procedure for reproducing an i-th repeating range contained in the repetitive reproduction mode setting table 190 is started. In this case, the reproduction mode of this reproduction procedure contained in the repetitive reproduction mode setting table 190 is the slow-motion reproducing mode. When a repetition start point changing request is made in step 303, the repetition start point of the i-th repeating range is overwritten with a new repetition start point to set a new repeating range and the new repeating range is stored in the storage device 16 in step 305. When a repetition end point changing request is made in step 304, the repetition end point of the i-th repeating range is overwritten with a new repetition end point to set a new repeating range and the new repeating range is stored in the storage device 16 in step 306. Upon the arrival of the reproducing procedure at the repetition end point of the i-th repeating range in step 302, i is incremented by one and then the loop 1 is repeated to carry out a reproducing procedure for reproducing an in+1-th repeating range, namely, the next repeating range.

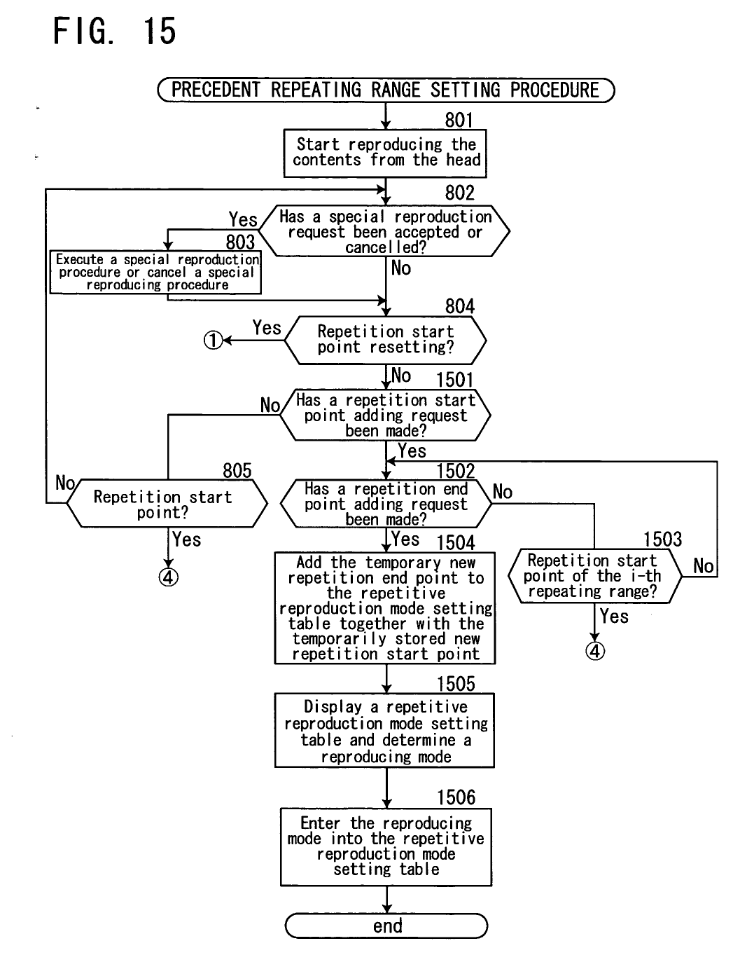

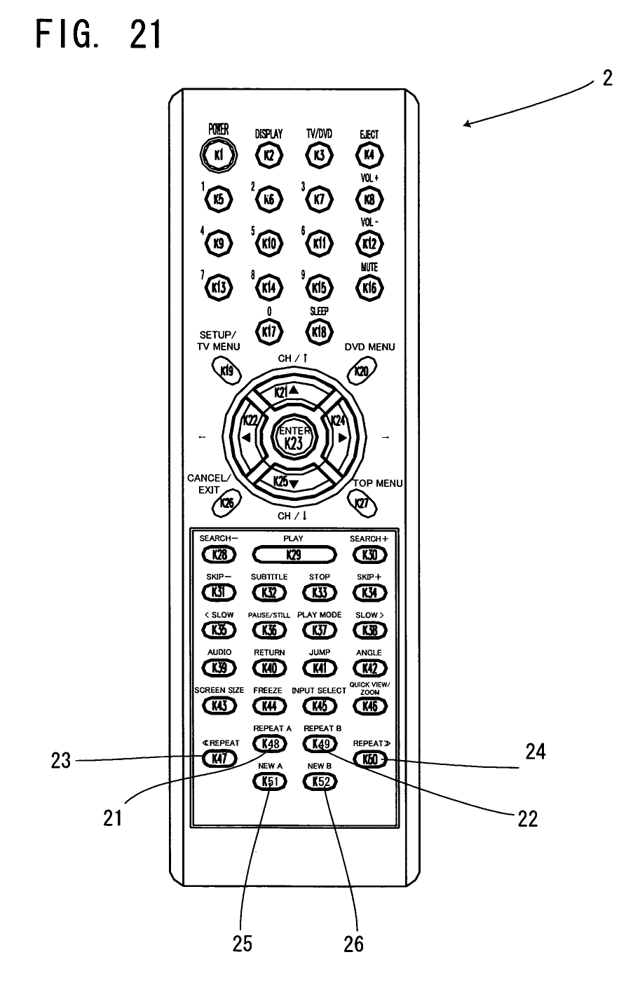

When a repetition start point resetting request is made in step 703 by operating a key 23 of a remote controller 2 shown in FIG. 21, a precedent repeating range setting procedure is carried out in step 705. FIG. 15 is a flowchart of the precedent repeating range setting procedure included in the repetitive reproduction procedure in the third embodiment according to the present invention. Steps of the precedent repeating range setting procedure shown in FIG. 15 conceptually similar to those of the repetitive reproduction procedure in the second embodiment shown in FIG. 8 are denoted by the same reference numerals and the description thereof will be omitted or simplified.

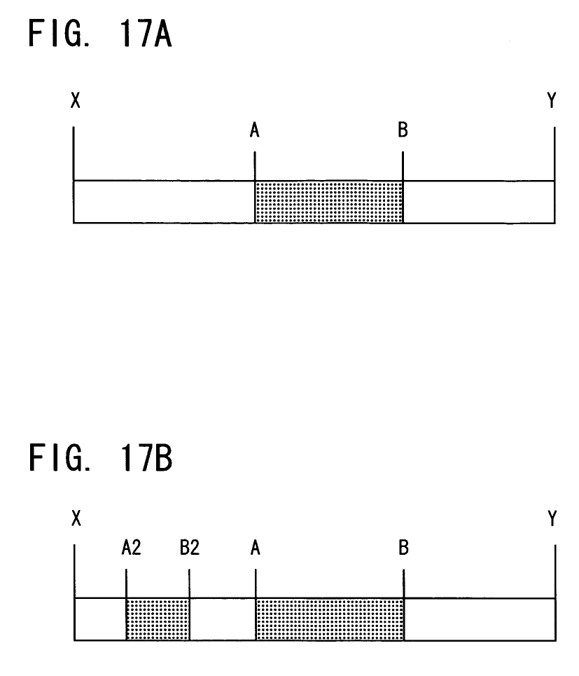

FIG. 17 is a diagram of assistance in explaining the precedent repeating range setting procedure in the third embodiment. The reproducing procedure starts reproducing contents from the head X of the contents shown in FIG. 17. If a key 25 (FIG. 21) is operated at a point A2 shown in FIG. 17B to make a repetition start point addition request in step 1501 during the reproducing procedure, the point A2 is assumed to be a temporary new repetition start point. The temporary new repetition start point A2 is stored in the storage device 16, and then a loop including steps 1502 and 1503 is carried out. If a key 26 for entering a repetition end point addition request has not been operated to make a repetition end point addition request before the reproducing procedure reaches the repetition start point A (FIG. 17) of an i-th repeating range, the precedent repeating range setting procedure is ended and the temporary new repetition start point is cancelled. Then the procedure returns to step 701 of the repetitive reproduction procedure shown in FIG. 14 to execute steps following step 701. In this case, any repeating range is not added. If a repetition end point addition request is made at a point B2 shown in FIG. 17B in step 1502 of the loop including steps 1502 and 1503, the point B2 is assumed to be a temporary new repetition end point. The temporary new repetition end point B2 is added to the repetitive reproduction mode setting table 190 together with the temporarily stored new repetition start point A2 in step 1504. Then, steps 1505 and 1506 similar to steps 1302 and 1303 shown in FIG. 13 are executed. In step 1505, a reproducing mode for reproducing a new repeating range defined by the repetition start point A2 and the repetition end point B2 is determined and is entered into the repetitive reproduction mode setting table 190. After thus additionally setting the new repeating range, the procedure returns to step 1401 shown in FIG. 14 to execute the following steps.

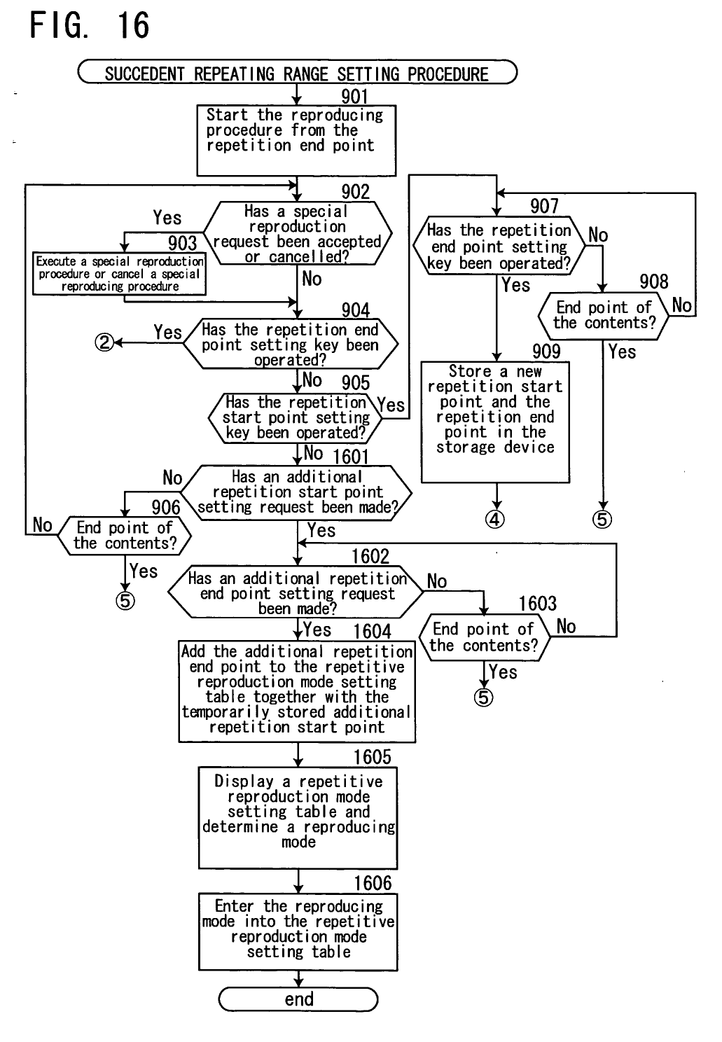

If the key 24 is operated in step 704 to make a succedent repeating range setting request, a succedent repeating range setting procedure is executed in step 706. FIG. 16 is a flowchart of the succedent repeating range setting procedure included in the repetitive reproduction procedure in the third embodiment. Steps of the succedent repeating range setting procedure shown in FIG. 16 conceptually similar to those of the repetitive reproduction procedure in the second embodiment shown in FIG. 9 are denoted by the same numerals and the description thereof will be omitted or simplified.

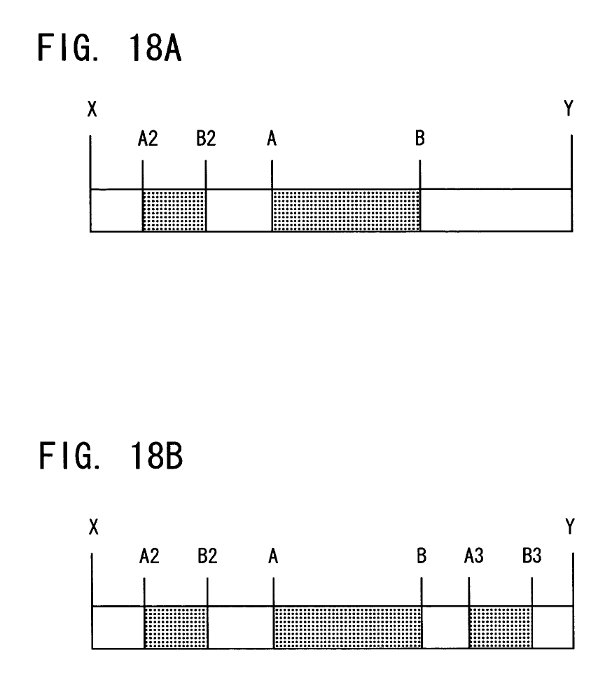

FIG. 18 is a diagram of assistance in explaining the succedent repeating range setting procedure in the third embodiment. Suppose that an i-th repeating range shown in FIG. 18 is defined by a repetition start point A and a repetition end point B. If the key 25 is operated at a point A3 shown in FIG. 18B in step 1601 to make an additional repetition start point setting request while the reproducing procedure is being continued after the i-th repeating range has been reproduced, the point A3 is assumed to be a temporary, additional repetition start point and is stored temporarily in the storage device 16. Then, a loop including steps 1602 and 1603 is executed. If the key 26 has not been operated to make an additional repetition end point setting request before the procedure reaches the end point Y shown in FIG. 18 of the contents, the succedent repeating range setting procedure is ended and the temporary, additional repetition start point is cancelled. Then, the procedure returns to step 302 shown in FIG. 14. Thus any repeating range is not added. If an additional repetition end point setting request is made at a point B3 shown in FIG. 18B in step 1602 of the loop, the point B3 is assumed to be an additional repetition end point. In step 1604, the additional repetition end point B3 is added to the repetitive reproduction mode setting table 190 together with the temporarily stored additional repetition start point A3. Steps 1605 and 1606 are conceptually similar to steps 1505 and 1506 shown in FIG. 15. In steps 1605 and 1606, a new repeating range defined by the repetition start point A3 and the repetition end point B3 is added to the repetitive reproduction mode setting table 190. Subsequently, the procedure returns to step 1401 shown in FIG. 14 to repeat the repetitive reproduction procedure.

When the succedent repeating range setting procedure is to be ended in step 906, 908 or 1603 upon the arrival or the reproducing procedure at the tail Y of the contents, the procedure returns to step 302 shown in FIG. 14 and the following steps are repeated. The key 25, namely, a repetition start point resetting key, and the key 26, namely, a repetition end point resetting key, are used for entering two different commands, respectively, in this embodiment. A single key may be used to enter the two different commands; the single key may be operated once to enter a repetition start point resetting command and may be operated twice to enter a repetition end point resetting command.

The DVD reproducing device in this embodiment provided with the LCD can set a plurality of repeating ranges and can carry out the additional repeating range setting procedure during the execution of the repetitive reproduction function, which enhances the operability of the DVD reproducing device. For example, when contents obtained by recording a broadcast program is reproduced, commercial messages can be skipped and only essential parts of the contents can be reproduced by setting repeating ranges containing only the essential parts of the contents. In this embodiment, only a single repeating range can be set by the first repeating range setting process in steps 203 to 1303 shown in FIG. 13 and the repetitive reproduction procedure is started immediately after one repeating range has been set. The repetitive reproduction procedure may be started after a plurality of repeating ranges have been set.

The DVD reproducing device in this embodiment provided with the LCD can set special reproducing modes including a slow-motion reproducing mode respectively for repeating ranges. The DVD reproducing device can carry out a variety of operations, such as repeating an operation for reproducing a repeating range 1 in a quick forward reproducing mode and subsequently reproducing a repeating range 2 in a slow-motion reproducing mode. Thus the operability of the DVD reproducing device is excellent. This embodiment requests an operation for setting a reproducing mode every time a repeating range is set. Usually, a normal reproducing mode may be used as a default reproducing mode and a normal reproducing mode may be automatically assigned to a repeating range. When the user requests setting a reproducing mode, a repetitive reproduction mode setting table shown in FIG. 20 may be displayed on the screen and the contents of the repetitive reproduction mode setting table may be reflected in the repetitive reproduction mode setting table 190.

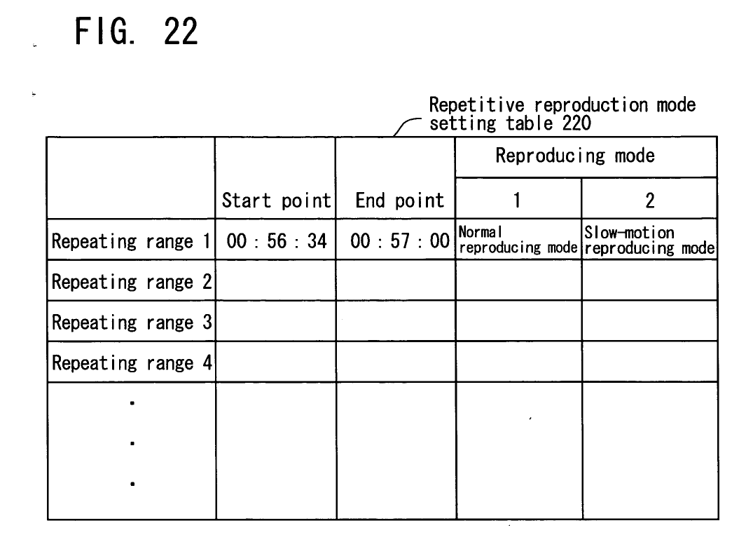

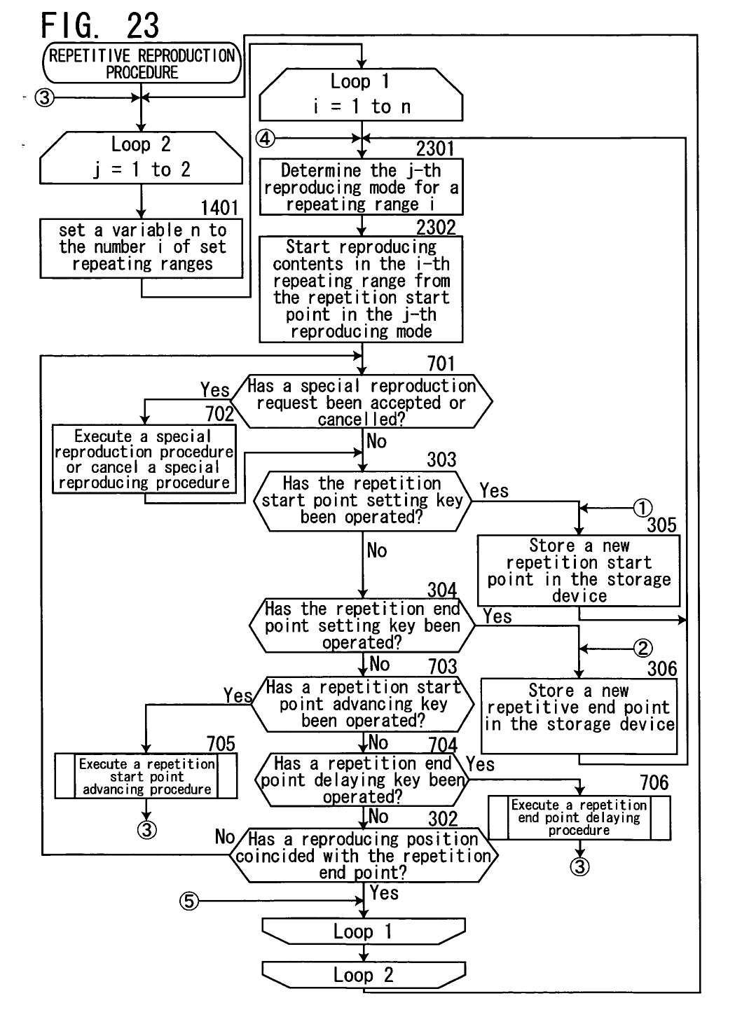

The number of set reproducing modes may be equal to the number of repetitions of repetitive reproduction. For example, a repetitive reproduction mode setting table 220 as shown in FIG. 22 is used to set a number of reproducing modes for equal to the number of repetitions of repetitive reproduction and a repetitive reproduction procedure shown in FIG. 23 is carried out instead of the repetitive reproduction procedure shown in FIG. 14. Thus, repeating ranges can be sequentially reproduced in a first reproducing mode 1, and then the repeating ranges can be sequentially reproduced in the second reproducing mode 2 according to the repetitive reproduction mode setting table 220. For example, when the repetitive reproduction mode setting table 220 is used, the first repeating range 1 can be repetitively reproduced sequentially in a normal reproducing mode, a reverse slow-motion reproducing mode, a normal reproducing mode, a reverse slow-motion reproducing mode and such. Such a repetitive reproduction procedure can be effectively applied to reproducing a scene of a close sports game. Although FIGS. 22 and 23 are supposed to employ only two reproducing modes, more than two reproducing modes may be employed.

In this embodiment, the repeating range adding procedure is the precedent repeating range setting procedure shown in FIG. 15 or the succedent repeating range setting procedure shown in FIG. 16. A request for repeating range addition may be accepted in steps 701 to 302 of the repetitive reproduction procedure shown in FIG. 14 to set a repeating range so as to overlap another repeating range. For example, when a repeating range entirely including a scene of a golf club swing motion is set, an additional repeating range including only a scene of the impact of the club head on a golf ball is set, and the additional repeating range is reproduced in a special reproducing mode, it is possible, for example, to reproduce the scene of the golf club swing motion in a normal reproducing mode, the scene of the impact of the club head on the golf ball in a slow-motion reproducing mode, and then the scene of the golf club swing motion in a normal reproducing mode.

Although the foregoing embodiments have been described on an assumption that the information recording medium is the DVD, the information recording medium may be, for example, a HDD, a VCD, a DVA, a CD or the like. The information recording medium may be a semiconductor storage device. The DVD device of the present invention is not limited to the generally called DVD player and may be any device capable of reproducing data from an information recording medium storing video contents and having additional functions, such as a DVD recorder capable of recording information, a television set with a built-in HDD, a video camera, a digital camera, a personal computer or the like.

Although the invention has been described in its preferred embodiments with a certain degree of particularity, obviously many changes and variations are possible therein. It is therefore to be understood that the present invention may be practiced otherwise than as specifically described herein without departing from the scope and sprit thereof.

1. A reproducing device having a repetitive reproduction function of repetitively reproducing a repeating range and capable carrying out a reproducing procedure for reproducing a single or a plurality of sets of contents recorded on an information recording medium, the reproducing device comprising:
a storage device storing a repeating range defined by a repetition start point and a repetition end point;
a reproducing unit;
a control unit; and
an input unit,
wherein a point where a point resetting request signal requesting resetting a repetition start point or a repetition end point is entered by operating the input unit during the execution of the repetitive reproduction function is stored as a new repetition start point or a new repetition end point in the storage device, and the repetitive reproduction function uses the new repetition start point or the new repetition end point.

2. The reproducing device having a repetitive reproduction function according to claim 1, wherein the input unit is provided with a repetition start point setting key and a repetition end point setting key, an input point entered by operating the repetition start point setting key during the execution of the repetitive reproduction function is used as a new repetition start point and a new repeating range having the new repetition start point is stored in the storage device or an input point entered by operating the repetition end point setting key during the execution of the repetitive reproduction function is used as a new repetition end point and a new repeating range having the new repetition end point is stored in the storage device.

3. The reproducing device having a repetitive reproduction function according to claim 1, wherein a reproducing procedure is started from a head part of one or a plurality of sets of contents stored on the information recording medium or a head part of one set of contents being reproduced when a repetition start point resetting request signal is provided by operating the repetition start point setting key during the execution of the repetitive reproduction function, and then the repetitive reproduction function is executed when it is decided that a reproducing position is within the repeating range.

4. The reproducing device having a repetitive reproduction function according to claim 1, wherein a predetermined advancing time or an advancing time specified by a user is stored in the storage device, when a repetition start point resetting request signal is provided during the execution of the repetitive reproduction function, the reproducing procedure is started from the repetition start point or a point advanced from a point where the repetition start point resetting request signal is provided by the advancing time, and the repetitive reproduction function is executed when it is decided that the reproducing position is in the repeating range or the repetitive reproduction function is executed after storing the point advanced from the repetition start point or the point when the repetition start point resetting request signal is provided by the advancing time as a new repetition start point in the storage device.

5. The reproducing device having a repetitive reproduction function according claim 1, wherein the reproducing procedure is continued to an end part of one or a plurality of sets of contents recorded on the information recording medium or an end part of the content unit being reproduced after the reproducing procedure has reached the repetition end point when a repetition end point resetting request signal is provided during the execution of the repetitive reproduction function, and the reproducing procedure returns to the repetition start point and the repetitive reproduction function is executed when a new repetition end point is set or the reproducing procedure reached the repetition end point.

6. The reproducing device with a repetitive reproduction function according to claim 1, wherein a predetermined delay time or a delay time specified by the user is stored in the storage device, and the repetitive reproduction function is executed after storing a new repetition end point at the delay time from the repetition end point or from a point where the repetition end point resetting request signal is provided in the storage device.

7. The reproducing device with a repetitive reproduction function according to claim 1, wherein the reproducing procedure is continued so as to meet a special reproduction request signal provided by the user by operating the input unit during the execution of the repetitive reproduction function, and the repeating range is reproduced repetitively by the reproducing procedure.

8. A repetitive reproduction function control program defining a reproducing procedure, to be carried out by a reproducing device having a repetitive reproduction function of repetitively reproducing a repeating range and capable of carrying out a reproducing procedure for reproducing a single or a plurality of sets of contents recorded on an information recording medium and including a storage device storing a repeating range defined by a repetition start point and a repetition end point, a reproducing unit, a control unit, and an input unit, the repetitive reproduction function control program comprising the steps of:
accepting a repetition start point setting request signal during the execution of the repetitive reproduction function;
storing a point where the repetition start point resetting request signal is accepted as a new repetition start point in the storage device when the repetition start point resetting request signal is provided;
accepting a repetition end point resetting request signal during the execution of the repetitive reproduction function; and
storing a point where the repetition end point resetting request signal is provided as a new repetition end point in the storage device.

9. A repeating range resetting method, to be carried out by a reproducing device having a repetitive reproduction function of repetitively reproducing a repeating range and capable of carrying out a reproducing procedure for reproducing a single or a plurality of sets of contents recorded on an information recording medium and including a storage device storing a repeating range defined by a repetition start point and a repetition end point, a reproducing unit, a control unit, and an input unit, the repeating range resetting method comprising the steps of:
determining a new repeating range defined by a new repetition start point and a repetition end point if a repetition start point resetting request signal is provided during the execution of a repetitive reproduction function or determining a new repeating range defined by a repetition start point and a new repetition end point if a repetition end point resetting request signal is provided during the execution of the repetitive reproduction function; and
executing the repetitive reproduction function for the new repeating range.
